(19) United States
(12) Patent Application Publication
(10) Pub. No.: US 2024/0318982 A1
(43) Pub. Date: Sep. 26, 2024

(54) SENSOR TAG, METHOD FOR READING SENSOR TAG, AND SENSOR SYSTEM USING SENSOR TAG

(71) Applicant: Mitsubishi Electric Corporation, Tokyo (JP)

(72) Inventor: Koichi FURUYA, Tokyo (JP)

(73) Assignee: Mitsubishi Electric Corporation, Tokyo (JP)

(21) Appl. No.: 18/734,874

(22) Filed: Jun. 5, 2024

Related U.S. Application Data
(63) Continuation of application No. PCT/JP2022/000158, filed on Jan. 6, 2022.

(51) Int. Cl. G01D 5/10; G01D 5/12; G01D 5/56; G01D 5/58

(52) U.S. Cl. CPC G01D 5/10; G01D 5/125; G01D 5/56; G01D 5/58

(57) ABSTRACT

A sensor tag includes a plurality of conductors to be arranged close to each other and to constitute a resonance element, and a sensing unit to be interposed between the plurality of conductors and to have a physical property that changes due to a change in a physical quantity of an object to be sensed by the sensing unit.

### CROSS REFERENCE TO RELATED APPLICATION

This application is a Continuation of PCT International Application No. PCT/JP2022/000158, filed on Jan. 6, 2022, which is hereby expressly incorporated by reference into the present application.

### TECHNICAL FIELD

The present disclosure relates to a sensor tag, a method for reading the sensor tag, and a sensor system using the sensor tag.

### BACKGROUND ART

A general tag represented by the tag described in Patent Literature 1, which is common to be a tag with the sensor tag according to the present disclosure, has a sensing unit. The sensing unit indicates a physical quantity of an object sensed by the sensing unit by a change in a feature of the sensing unit based on an electromagnetic wave reflection characteristic of the sensing unit, for example, by a change in dielectric constant or conductivity described in Patent Literature 1.

### CITATION LIST

### Patent Literature

Patent Literature 1: JP 2021-89725 A

### SUMMARY OF INVENTION

### Technical Problem

However, in the above-described tag, there is a problem that the above-described sensing unit cannot sense the physical quantity of the object unless the dielectric constant or the conductivity of the sensing unit changes even though the physical quantity of the object changes.

An object of the present disclosure is to provide a sensor tag capable of sensing a physical quantity of an object even if conductivity or a dielectric constant of a sensing unit does not change even though the physical quantity of the object changes.

### Solution to Problem

In order to solve the above-described problem, a sensor tag according to the present disclosure includes a plurality of conductors arranged close to each other and to constitute a resonance element; and a sensing member interposed between the plurality of conductors and having a physical property that changes due to a change in a physical quantity of an object to be sensed by the sensing member.

### Advantageous Effects of Invention

With the sensor tag according to the present disclosure, a physical quantity of an object can be sensed even if conductivity or a dielectric constant of a sensing unit does not change even though the physical quantity of the object changes.

### BRIEF DESCRIPTION OF DRAWINGS

FIG. 1 illustrates a configuration of a sensor tag ST of a first embodiment.

FIG. 2A illustrates an operation (part 1 (1)) of the sensor tag ST of the first embodiment. FIG. 2B illustrates an operation (part 1 (2)) of the sensor tag ST of the first embodiment. FIG. 2C illustrates an operation (part 1 (3)) of the sensor tag ST of the first embodiment.

FIG. 3A illustrates an operation (part 2 (1)) of the sensor tag ST of the first embodiment. FIG. 3B illustrates an operation (part 2 (2)) of the sensor tag ST of the first embodiment.

FIG. 4 illustrates an operation (part 3) of the sensor tag ST of the first embodiment.

FIG. 5 illustrates a configuration (part 1) of a sensor tag ST of a second embodiment.

FIG. 6 illustrates a configuration (part 2) of the sensor tag ST of the second embodiment.

FIG. 7 illustrates a configuration (part 3) of the sensor tag ST of the second embodiment.

FIGS. 8A to 8C each is a schematic diagram illustrating a displacement and a displacement amount of the sensor tag ST of the second embodiment.

FIG. 9 illustrates frequency characteristics (part 1) of a reflection amount of the second embodiment.

FIG. 10 illustrates frequency characteristics (part 2) of the reflection amount of the second embodiment.

FIG. 11 illustrates frequency characteristics (part 3) of the reflection amount of the second embodiment.

FIG. 12 illustrates a configuration of a sensor tag ST of a third embodiment.

FIG. 13 illustrates an electric circuit DK of a sensing unit 32 of the third embodiment.

FIG. 14 illustrates a configuration (part 1) of a fourth embodiment.

FIG. 15 illustrates a configuration (part 2) of the fourth embodiment.

FIG. 16 illustrates frequency characteristics of a reflection amount in the fourth embodiment.

FIG. 17 illustrates a configuration of a sensor tag ST of a fifth embodiment.

FIG. 18A illustrates a configuration (part 1) of a sensor tag ST of a sixth embodiment. FIG. 18B illustrates a configuration (part 2) of the sensor tag ST of the sixth embodiment. FIG. 18C illustrates a configuration (part 3) of the sensor tag ST of the sixth embodiment.

FIG. 19 illustrates frequency characteristics (without displacement) of a reflection amount of the sixth embodiment.

FIG. 20 illustrates frequency characteristics (displacement in an X direction) of the reflection amount of the sixth embodiment.

FIG. 21 illustrates frequency characteristics (displacement in a Y direction) of the reflection amount of the sixth embodiment.

FIG. 22 illustrates frequency characteristics (displacement in a Z direction) of the reflection amount of the sixth embodiment.

FIG. 23 illustrates an arrangement (part 1) of a sensor tag ST of a seventh embodiment.

FIG. 24 illustrates an arrangement (part 2) of the sensor tag ST of the seventh embodiment.

FIG. 25 illustrates a shape and dimensions of the sensor tag ST of the seventh embodiment.

FIG. 26 illustrates an operation of the sensor tag ST of the seventh embodiment.

FIG. 27 illustrates calculation results (vibration in the X direction) of an nth-order coefficient Cn of the seventh embodiment.

FIG. 28 illustrates calculation results (vibration in the Y direction) of the nth-order coefficient Cn of the seventh embodiment.

FIG. 29 illustrates calculation results (vibration in the Z direction) of the nth-order coefficient Cn of the seventh embodiment.

FIG. 30 illustrates a configuration of a sensor system SS of an eighth embodiment.

FIG. 31 illustrates a configuration of a sensor system SS of a ninth embodiment.

### DESCRIPTION OF EMBODIMENTS

Embodiments of a sensor tag, a method for reading a sensor tag, and a sensor system using a sensor tag according to the present disclosure will be described.

Hereinafter, in order to facilitate description and understanding, names of a plurality of members may be collectively referred to by one reference numeral. For example, one reference numeral “11” may collectively refer to both of the two names “conductor 11a” and “conductor 11b”.

### First Embodiment

### First Embodiment

A sensor tag of a first embodiment will be described.

### Configuration of First Embodiment

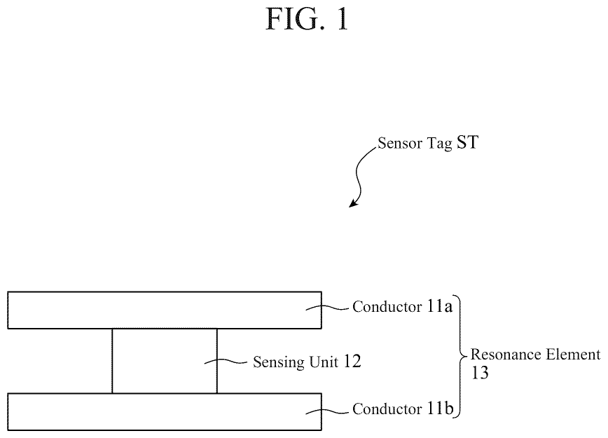

FIG. 1 illustrates a configuration of a sensor tag ST of the first embodiment.

As illustrated in FIG. 1, the sensor tag ST of the first embodiment includes a plurality of conductors 11, that is, a conductor 11a and a conductor 11b, and a sensing unit 12.

The “plurality of conductors 11” corresponds to a “plurality of conductors”, the sensing unit 12 corresponds to a “sensing unit”, and a resonance element 13 corresponds to a “resonance element”.

The conductor 11a and the conductor 11b are elements constituting the resonance element 13. The conductor 11a and the conductor 11b are close to each other, and specifically, are close to each other so as to be electromagnetically couplable.

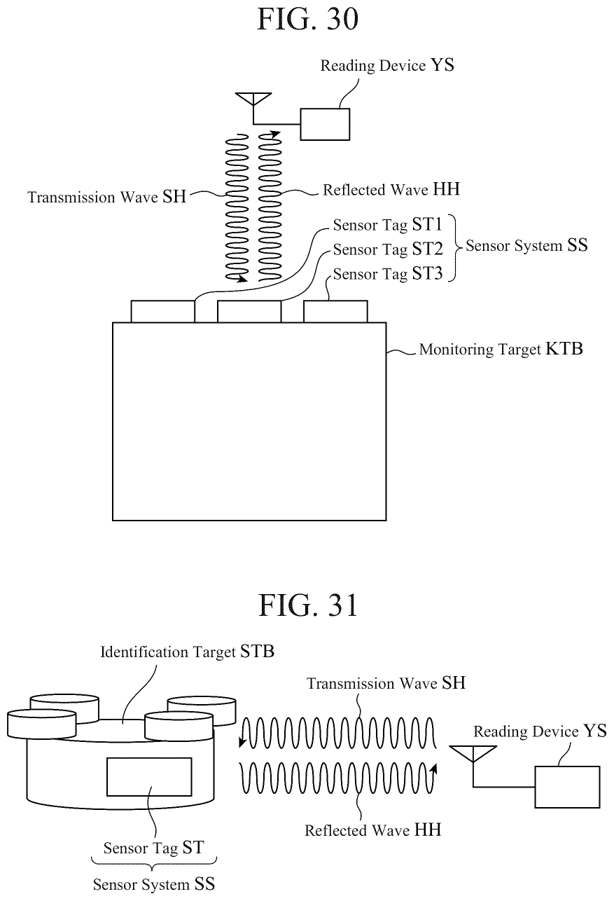

The sensing unit 12 is interposed between the conductor 11a and the conductor 11b. In the sensing unit 12, a physical property changes with a change in a physical quantity BR (not illustrated) of an object TB (corresponding to, for example, a monitoring target KTB illustrated in FIG. 30 and an identification target STB illustrated in FIG. 31) to be sensed by the sensing unit 12, and for example, a shape of the sensing unit 12 changes.

### Operation of First Embodiment

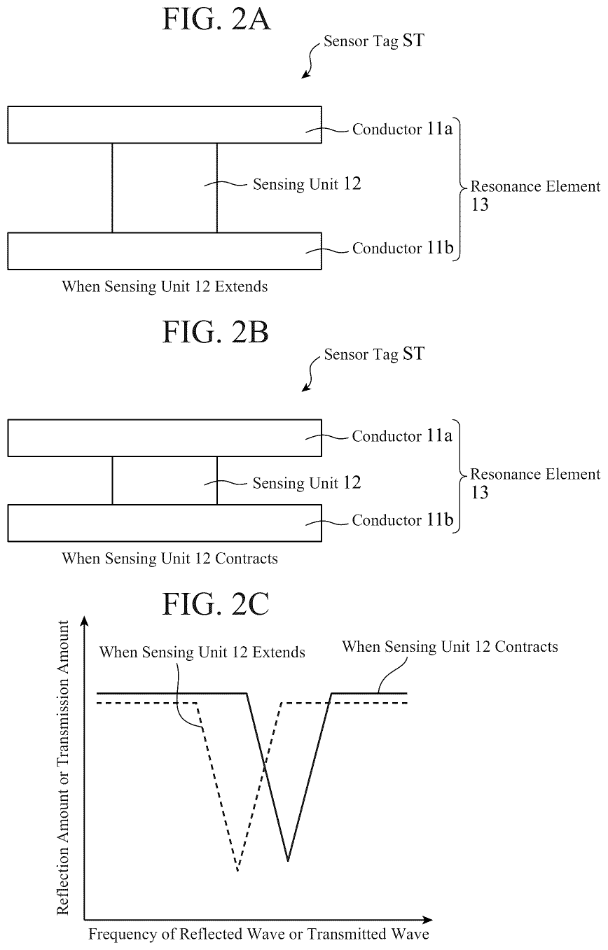

FIGS. 2A and 2B illustrate an operation (part 1) of the sensor tag ST of the first embodiment.

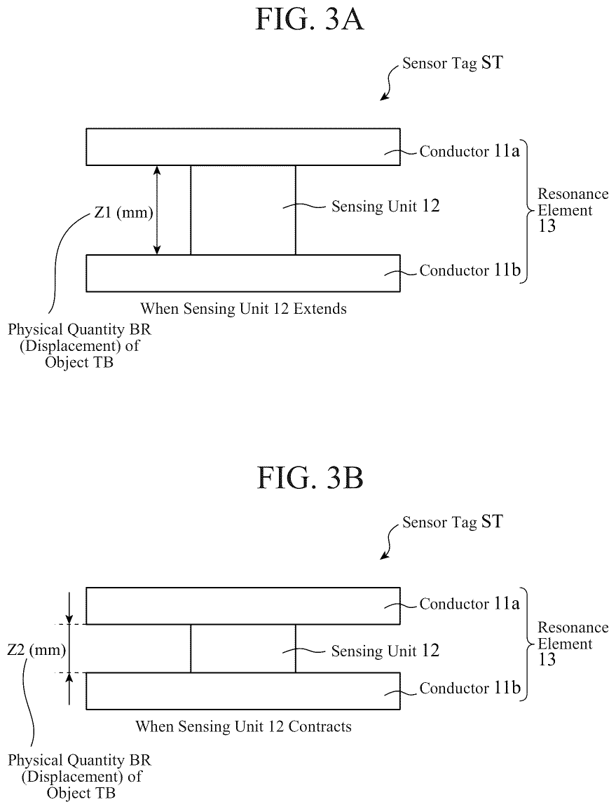

FIGS. 3A and 3B illustrate an operation (part 2) of the sensor tag ST of the first embodiment.

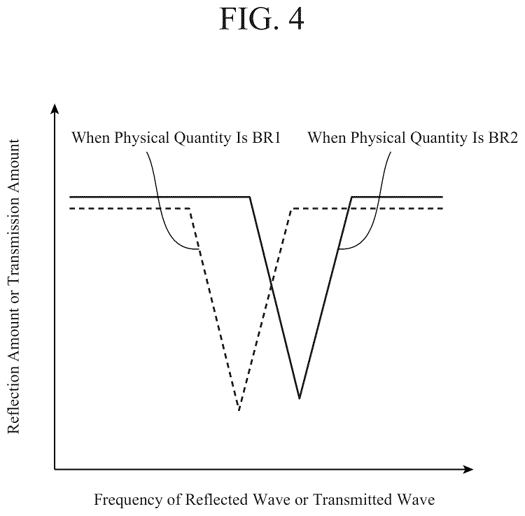

FIG. 4 illustrates an operation (part 3) of the sensor tag ST of the first embodiment.

When the physical quantity BR of the object TB to be sensed by the sensing unit 12 changes, the shape of the sensing unit 12 changes in the sensor tag ST. A combination of the type of the physical quantity BR of the object TB and the type of the sensing unit 12 is, for example, as follows.

(1) The physical quantity BR of the object TB is displacement, mechanical vibration, pressure, or the like, and the sensing unit 12 is a spring, rubber, or the like.

(2) The physical quantity BR of the object TB is temperature or the like, and the sensing unit 12 is a thermoplastic resin or the like.

As described above, when the shape of the sensing unit 12 changes, the relative positional relationship between the conductor 11a and the conductor 11b, in other words, the distance between the conductor 11a and the conductor 11b changes.

As described above, when the relative positional relationship between the conductor 11a and the conductor 11b changes, frequency characteristic of a reflection coefficient or a transmission coefficient of the resonance element 13 changes.

Here, the “reflection coefficient” and the “transmission coefficient” represent an amount of reflection or transmission of an electromagnetic wave and a change amount of a phase at that time.

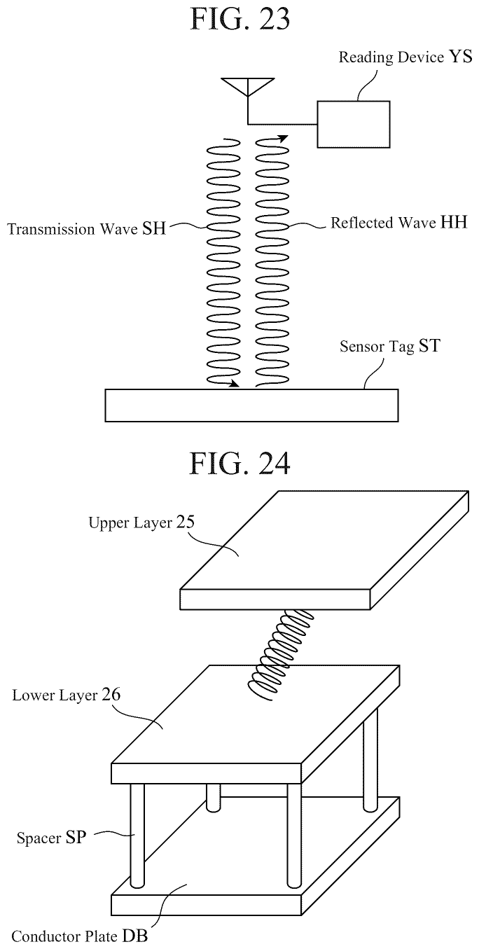

When the change in the frequency characteristic of the reflection coefficient or the transmission coefficient of the resonance element 13 caused by the change in the physical quantity BR of the object TB is to be observed, a reading device YS (for example, illustrated in FIG. 23) irradiates the sensor tag ST with an electromagnetic wave (corresponding to, for example, a transmission wave SH illustrated in FIG. 23), and receives a reflected wave or a transmitted wave (corresponding to, for example, a reflected wave HH illustrated in FIG. 23) having a frequency characteristic changed due to the change in the physical quantity BR of the object TB from the sensor tag ST, thereby observing the frequency characteristic of the reflected wave or the transmitted wave.

On the basis of the observed frequency characteristics of the reflected wave HH and the like, by referring to the correspondence relationship (illustrated in FIG. 2C) between the frequency characteristics of the reflected wave HH and the like and the state of the sensing unit 12 calculated in advance or acquired in advance by an experiment, it is possible to estimate the state of the sensing unit 12, that is, the extension/contraction state (illustrated in FIG. 2A and FIG. 2B) that is a change in shape.

Furthermore, the physical quantity of the object TB can be estimated from the correspondence relationship (illustrated in FIG. 3A and FIG. 3B) between the state of the sensing unit 12 and the physical quantity BR of the object TB. For example, when the length of the sensing unit 12, in other words, the distance between the conductor 11a and the conductor 11b is Z1 (mm), it can be estimated that the physical quantity BR of the object TB is Z1 (mm), and similarly, when the distance between the conductor 11a and the conductor 11b is Z2 (mm), it can be estimated that the physical quantity of the object TB is Z2 (mm).

Instead of using the above two correspondence relationships (illustrated in FIGS. 2A to 2C and FIGS. 3A and 3B), a correspondence relationship (illustrated in FIG. 4) between the frequency characteristics of the reflected wave HH and the like and the physical quantity BR of the object TB may be used. Thus, for example, a physical quantity BR1 of the object TB and a physical quantity BR2 of the object TB can be distinguished.

### Effects of First Embodiment

As described above, in the sensor tag ST of the first embodiment, when the physical quantity BR of the object TB changes, the shape which is an example of physical properties of the sensing unit 12 changes, thereby changing the relative position between the conductor 11a and the conductor 11b. Furthermore, the frequency characteristics of the reflected wave HH and the like due to reflection or the like of the sensor tag ST change as the reflection coefficient or the transmission coefficient of the resonance element 13 changes due to a change in the relative position between the conductor 11a and the conductor 11b. As a result, the physical quantity BR of the object

TB can be estimated by observing the above-described frequency characteristics.

With the sensor tag ST of the first embodiment functioning as described above, it is possible to sense the physical quantity BR of the object TB without requiring electrical characteristics (conductivity or dielectric constant) which are required for conventional sensing units.

### Second Embodiment

### Second Embodiment

A sensor tag of a second embodiment will be described.

The sensor tag ST of the second embodiment senses displacement or vibration of the object TB as the physical quantity BR of the object TB.

### <Configuration of Second Embodiment>

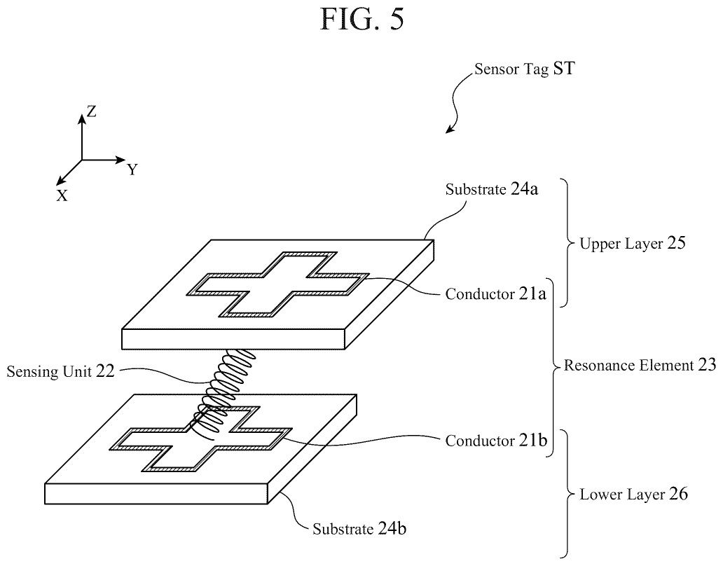

FIG. 5 illustrates a configuration (part 1) of the sensor tag ST of the second embodiment.

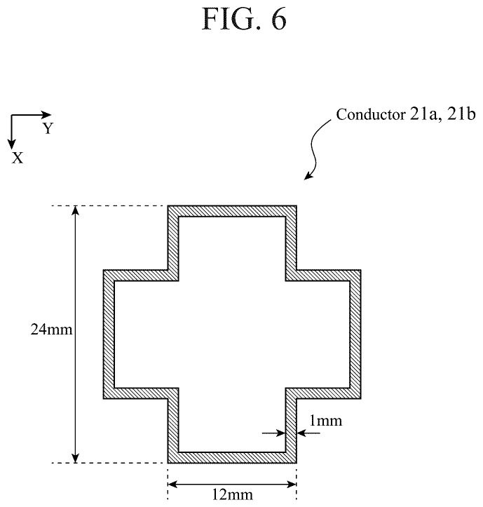

FIG. 6 illustrates a configuration (part 2) of the sensor tag ST of the second embodiment.

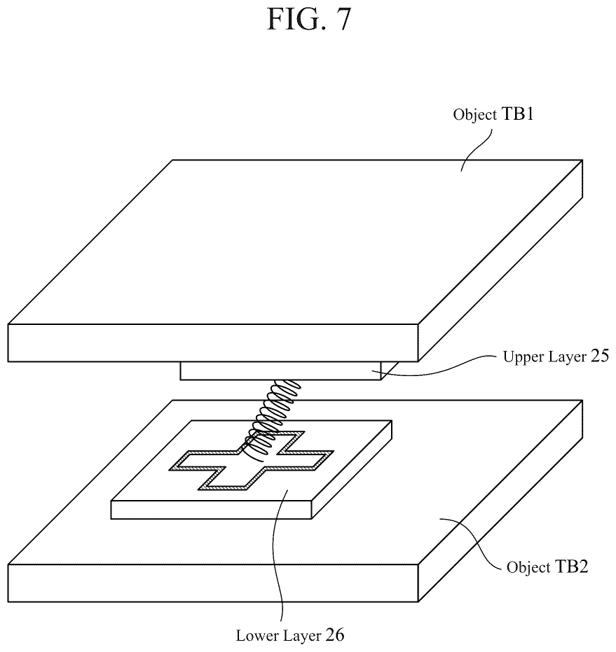

FIG. 7 illustrates a configuration (part 3) of the sensor tag ST of the second embodiment.

As illustrated in FIG. 5, the sensor tag ST of the second embodiment has a configuration basically similar to the configuration of the sensor tag ST of the first embodiment (illustrated in FIG. 1).

On the other hand, the sensor tag ST of the second embodiment is different from the sensor tag ST of the first embodiment in that the sensing unit 22 is a spring (of any material) as illustrated in FIG. 5.

The sensor tag ST of the second embodiment includes a substrate 24a and a substrate 24b as illustrated in FIG. 5. The substrate 24a supports a conductor 21a, and similarly, the substrate 24b supports a conductor 21b. The conductor 21a and the conductor 21b have dimensions illustrated in FIG. 6, for example.

As illustrated in FIG. 5, the conductor 21a and the substrate 24a constitute an upper layer 25 of the sensor tag ST, and similarly, the conductor 21b and the substrate 24b constitute a lower layer 26 of the sensor tag ST.

As illustrated in FIG. 7, the upper layer 25 is attached to the bottom surface of the object TB1 to be sensed, while the lower layer 26 is attached to the upper surface of the object TB2 to be sensed. Specifically, the upper layer 25 and the lower layer 26 are provided between two separated components constituting a structure (bridge or the like), or are provided between two separated components constituting an electronic device.

### Operation of Second Embodiment

Hereinafter, it is assumed that the position of the object TB1 (illustrated in FIG. 7) is fixed while the position of the object TB2 (illustrated in FIG. 7) is displaced.

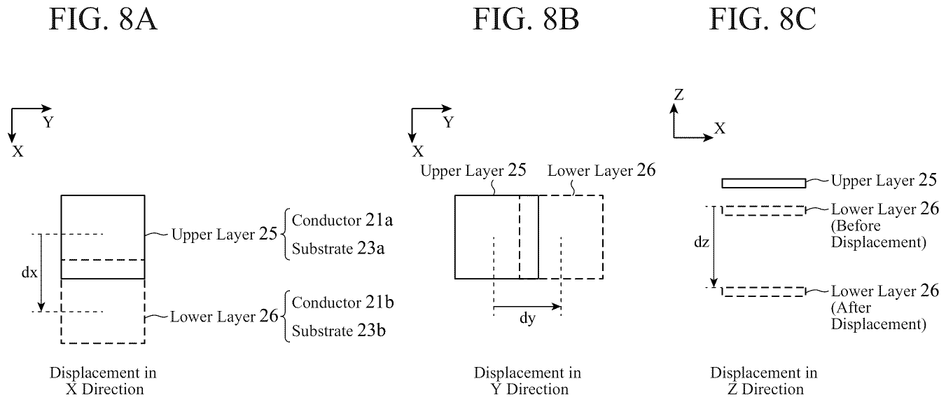

FIGS. 8A to 8C each is a schematic diagram illustrating a displacement and a displacement amount of the sensor tag ST of the second embodiment.

Here, a “reference state” is defined as a state in which the upper layer 25 and the lower layer 26 completely overlap each other when viewed from a Z-axis direction, and a state in which the position of the lower layer 26 in a Z direction is a specific position (FIG. 8C illustrates the “lower layer 26 (before displacement)”). Displacement amounts dx, dy, and dz (in units of mm) are defined as amounts displaced from the “reference state” as illustrated in FIGS. 8A to 8C.

When the position of the object TB2 is displaced, the shape of the sensing unit 22 changes, the relative position between the conductor 21a and the conductor 21b changes, and the frequency characteristic of the reflection coefficient or the transmission coefficient of a resonance element 23 changes as in the first embodiment.

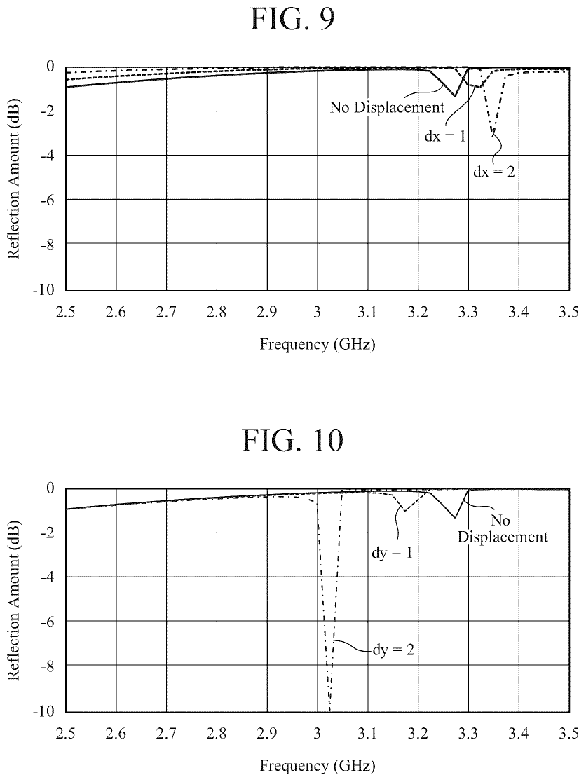

FIG. 9 illustrates frequency characteristics (part 1) of the reflection amount of the second embodiment.

FIG. 10 illustrates frequency characteristics (part 2) of the reflection amount of the second embodiment.

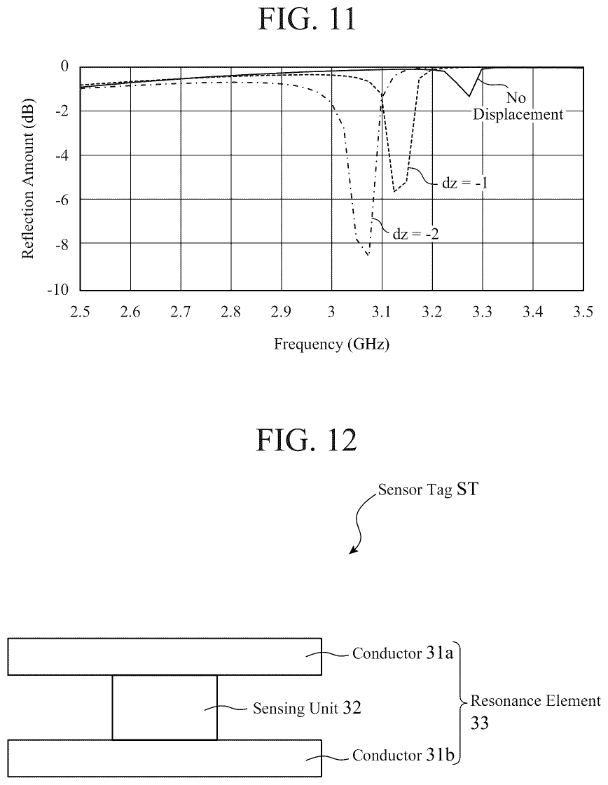

FIG. 11 illustrates frequency characteristics (part 3) of the reflection amount of the second embodiment.

The frequency characteristics of the reflection amount illustrated in FIGS. 9 to 11 indicate the magnitude of the reflection coefficient of the sensor tag ST with respect to an electromagnetic wave, more precisely, an X polarized wave (polarized wave vibrating in an X direction) when the object TB2 is displaced in any one of three directions of X, Y, and Z.

The frequency characteristics of the reflection amount illustrated in FIGS. 9 to 11 are calculated, for example, by two-dimensionally arranging a large number of sensor tags ST (illustrated in FIG. 1) at intervals of 25 mm on an XY plane in order to increase the reflection amount to be obtained.

As illustrated in FIGS. 9 to 11, when the object TB2 is displaced in any one of the X, Y, and Z directions, the frequency characteristic of the reflection amount changes. On the other hand, the frequency characteristic of the reflection amount differs depending on in which the direction of X, Y, and Z the object TB2 is displaced, and whether the displacement amount is large or small.

As in the first embodiment, the reading device YS irradiates the sensor tag ST with the transmission wave SH and receives the reflected wave HH or the like from the sensor tag ST, thereby observing the frequency characteristics of the reflected wave HH and the like of the resonance element 23.

In a manner substantially similar to that in the first embodiment, on the basis of the observed frequency characteristics of the reflected wave HH and the like, by referring to the correspondence relationship, calculated in advance or acquired in advance by an experiment, between the frequency characteristics of the reflected wave HH and the like and the state of the sensing unit 22, it is possible to estimate the state of the sensing unit 22 and further estimate the displacement direction and the displacement amount of the object TB2.

### Effects of Second Embodiment

As described above, in the sensor tag ST of the second embodiment, the displacement direction and the displacement amount of the object TB2 can be sensed even if the conductivity or the dielectric constant of the sensing unit 22 does not change in response to the change of the object TB2.

### Third Embodiment

### Third Embodiment

A sensor tag of a third embodiment will be described.

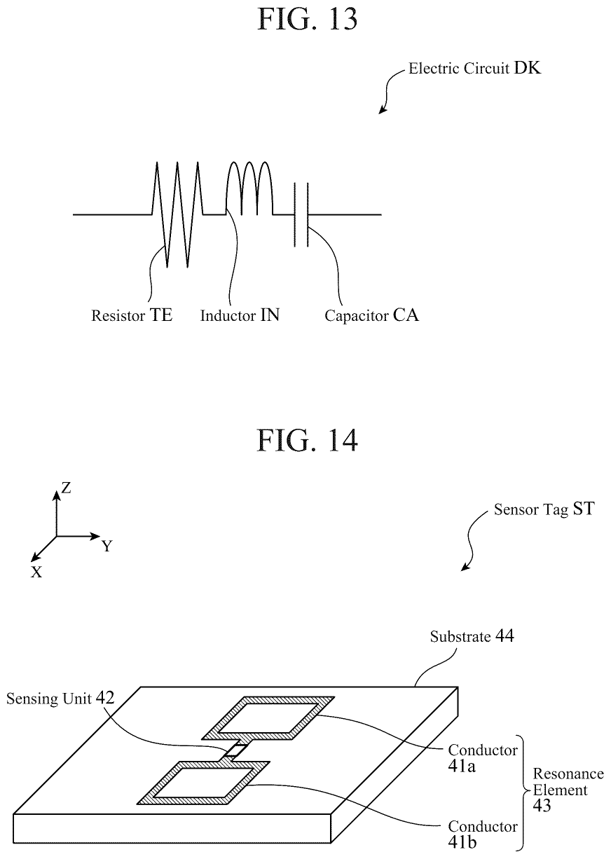

In the sensor tag ST of the third embodiment, in a sensing unit 32, a circuit constant of an electric circuit DK changes (illustrated in FIG. 13).

### Configuration of Third Embodiment

FIG. 12 illustrates a configuration of the sensor tag ST of the third embodiment.

FIG. 13 illustrates the electric circuit DK of the sensing unit 32 of the third embodiment.

As illustrated in FIG. 12, the sensor tag ST of the third embodiment has a configuration basically similar to the configuration of the sensor tag ST of the first embodiment (Illustrated in FIG. 1).

In the sensor tag ST of the third embodiment, unlike the sensor tag ST of the first embodiment, in the sensing unit 32, a circuit constant of the electric circuit DK (illustrated in FIG. 13) of the sensing unit 32 changes with a change in the physical quantity BR of the object TB.

### Operation of Third Embodiment

When the physical quantity BR of the object TB changes, the circuit constant of the electric circuit DK of the sensing unit 32 changes, and specifically, as illustrated in FIG. 13, for example, the size of a resistor TE, an inductor IN, or a capacitor CA constituting the electric circuit DK equivalent to a varactor diode which is an active element changes.

When the physical quantity BR of the object TB changes, in other words, when the value of the reverse bias voltage applied to the varactor diode changes, for example, the value of the capacitor CA of the electric circuit DK changes due to the property of the varactor diode.

The combination of the physical quantity BR of the object TB and the sensing unit 32 is, for example, as follows.
(1) The physical quantity BR of the object TB is a voltage, an electric field, or the like, and the sensing unit 32 is a diode or the like.
(2) The physical quantity BR of the object TB is a magnetic field or the like, and the sensing unit 32 is a magnetic sensor or the like.
(3) The physical quantity of the object TB is light or the like, and the sensing unit 32 is a CdS sensor or the like.
(4) The object TB is temperature or the like, and the sensing unit 32 is a thermistor or the like.
(5) The object TB is humidity or the like, and the sensing unit 32 is a humidity sensor or the like.
(6) The object TB is a gas or the like, and the sensing unit 32 is a gas sensor or the like.

When the circuit constant of the electric circuit DK of the sensing unit 32 changes, the electrical connection state (situation of how a conductor 31a and a conductor 31b are electrically connected) changes, and the frequency characteristic of the reflection coefficient or the transmission coefficient of a resonance element 33 changes.

As in the first embodiment, the reading device YS irradiates the sensor tag ST with the transmission wave SH and receives the reflected wave HH or the like from the sensor tag ST, thereby observing the frequency characteristics of the reflected wave HH and the like of the resonance element 33.

In a manner substantially similar to that in the first embodiment, on the basis of the observed frequency characteristics of the reflected wave HH and the like, by referring to the correspondence relationship, calculated in advance or acquired in advance by an experiment, between the frequency characteristics of the reflected wave HH and the like and the state of the sensing unit 32, it is possible to estimate the state of the sensing unit 32 and further estimate the physical quantity BR of the object TB.

### Effects of Third Embodiment

As described above, in the sensor tag ST of the third embodiment, the physical quantity BR of the object TB can be estimated even if the conductivity or dielectric constant of the sensing unit 32 does not change in response to the change in the object TB.

### Fourth Embodiment

### Fourth Embodiment

A sensor tag of a fourth embodiment will be described.

The sensor tag ST of the fourth embodiment senses an electric field which is the physical quantity BR of the object TB.

### Configuration of Fourth Embodiment

FIG. 14 illustrates a configuration (part 1) of the fourth embodiment.

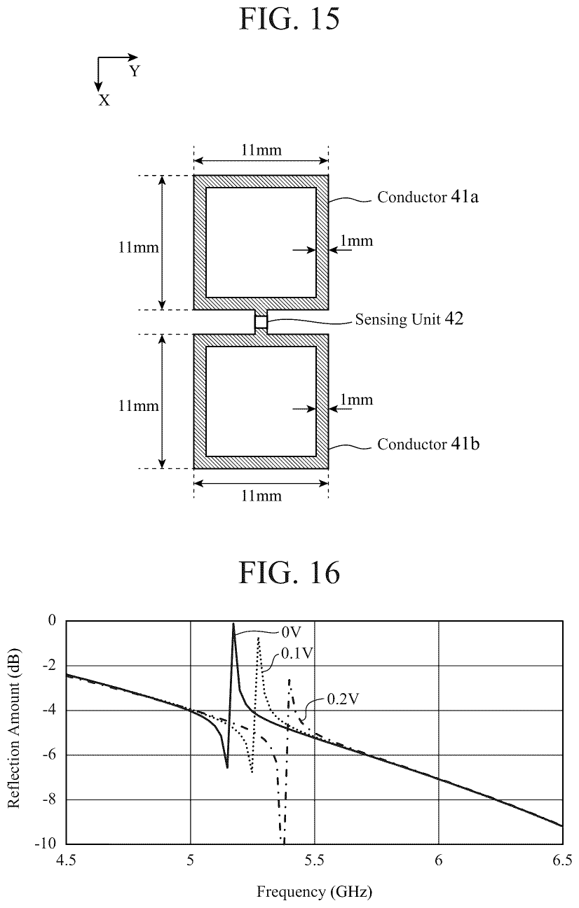

FIG. 15 illustrates a configuration (part 2) of the fourth embodiment.

As illustrated in FIG. 14, the sensor tag ST of the fourth embodiment has a configuration basically similar to the configuration of the sensor tag ST of the first embodiment (illustrated in FIG. 1).

In the sensor tag ST of the fourth embodiment, unlike the sensor tag ST of the first embodiment, a sensing unit 42 is a varactor diode. The sensor tag ST of the fourth embodiment also includes a substrate 44. The substrate 44 supports a conductor 41a and a conductor 41b. The conductor 41a and the conductor 41b have dimensions illustrated in FIG. 15, for example.

### Operation of Fourth Embodiment

FIG. 16 illustrates frequency characteristics of the reflection amount of the fourth embodiment.

Hereinafter, it is assumed that the sensor tag ST is disposed in the vicinity of an electromagnetic noise source on the electronic circuit, for example, an IC chip.

The above-described electromagnetic noise source emits an electromagnetic wave, an electric field is generated between the conductor 41a and the conductor 41b due to the electromagnetic wave, and as a result, a voltage is generated between the conductor 41a and the conductor 41b. When the direction of the generated voltage is along the direction of the reverse bias voltage of the varactor diode of the sensing unit 42, the circuit constant of the sensing unit 42, specifically, the capacitance of the capacitor changes depending on the magnitude of the voltage.

When the capacitance of the capacitor changes, the electrical connection state of the conductor 41a and the conductor 41b changes, and as a result, the frequency characteristics of the reflected wave HH and the like of the sensor tag ST change.

FIG. 16 is calculated by a method similar to that in FIGS. 9 to 11 of the second embodiment. As illustrated in FIG. 16, when the value of the reverse bias voltage changes to 0 V, 0.1 V, and 0.2 V, the frequency characteristic of the reflection amount changes.

As in the first embodiment, the reading device YS irradiates the sensor tag ST with the transmission wave SH and receives the reflected wave HH or the like from the sensor tag ST, thereby observing the frequency characteristics of the reflected wave HH or the like of a resonance element 43.

In a manner substantially similar to that in the first embodiment, on the basis of the observed frequency characteristics of the reflected wave HH and the like, by referring to the correspondence relationship, calculated in advance or acquired in advance by an experiment, between the frequency characteristics of the reflected wave HH and the like and the state of the sensing unit 22, it is possible to estimate the state of the sensing unit 22 and further estimate the reverse bias voltage applied to the sensing unit 42, that is, estimate the magnitude of the electric field of the object TB.

### Effects of Fourth Embodiment

As described above, in the sensor tag ST of the fourth embodiment, the electric field of the object TB can be sensed even if the conductivity or dielectric constant of the sensing unit 42 does not change in response to the change in the electric field of the object TB.

### Modification

Instead of the above-described electromagnetic noise propagating through the space, that is, what is called radiation noise, electromagnetic noise propagating through the wiring of the electronic circuit, that is, what is called conduction noise can be sensed. In a case where conduction noise is to be sensed, two places where a voltage due to electromagnetic noise occurs on the wiring are electrically connected in one-to-one correspondence to the conductor 41a and the conductor 41b, that is, wiring is performed so that a voltage due to electromagnetic noise occurs between the conductor 41a and the conductor 41b. Thus, conduction noise can be sensed as described above.

### Fifth Embodiment

### Fifth Embodiment

A sensor tag of a fifth embodiment will be described.

Unlike the first to fourth embodiments in which the physical quantity BR of the object TB is directly sensed, the sensor tag ST of the fifth embodiment indirectly senses the physical quantity BR of the object TB by combining a plurality of sensing units.

### Configuration of Fifth Embodiment

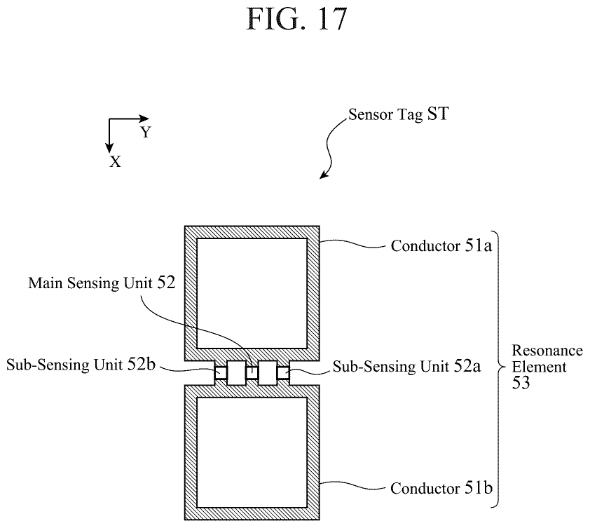

FIG. 17 illustrates a configuration of a sensor tag ST of the fifth embodiment.

As illustrated in FIG. 17, the sensor tag ST of the fifth embodiment has a configuration basically similar to the configuration of the sensor tag ST of the first embodiment (illustrated in FIG. 1).

The sensor tag ST of the fifth embodiment includes a sub-sensing unit 52a and a sub-sensing unit 52b in addition to a main sensing unit 52 (this corresponds to the sensing unit 42 of the fourth embodiment illustrated in FIG. 14). The sub-sensing unit 52a and the sub-sensing unit 52b are, for example, vibration sensors using piezoelectric elements. The sub-sensing unit 52a and the sub-sensing unit 52b are provided in parallel to the main sensing unit 52 between a conductor 51a and a conductor 51b.

### Operation of Fifth Embodiment

In the sensor tag ST of the fifth embodiment, when the physical quantity BR of the object TB changes, physical properties of the sub-sensing unit 52a and the sub-sensing unit 52b change. When the physical properties of the sub-sensing unit 52a and the sub-sensing unit 52b change, the physical properties of the main sensing unit 52 change.

The main sensing unit 52, unlike the sensing units 12 to 42 of the first to fourth embodiments that directly sense the physical quantity BR of the object TB, indirectly senses the physical quantity BR via the sub-sensing unit 52a and the sub-sensing unit 52b.

When the object TB vibrates, the sub-sensing unit 52a and the sub-sensing unit 52b generate a voltage. Thus, a voltage is generated between the conductor 51a and the conductor 51b.

When the direction of the voltage between the conductor 51a and the conductor 51b is along the direction of the reverse bias voltage of the varactor diode of the main sensing unit 52, the circuit constant of the main sensing unit 52, specifically, the size of the capacitor changes depending on the magnitude of the voltage.

Thereafter, as with the sensor tag ST of the fourth embodiment, the magnitude of the reverse bias voltage applied to the main sensing unit 52 can be estimated by observing the frequency characteristic of the reflection amount, and furthermore, the vibration of the object TB can be estimated from the magnitude of the reverse bias voltage.

### Effects of Fifth Embodiment

As described above, in the sensor tag ST of the fifth embodiment, the vibration of the object TB can be sensed even if the conductivity or dielectric constant of the main sensing unit 52, the sub-sensing unit 52a, and the sub-sensing unit 52b does not change in response to the change in the physical quantity BR of the object TB.

### Sixth Embodiment

### Sixth Embodiment

A sensor tag of a sixth embodiment will be described.

A technology of chipless RFID is used for the sensor tag ST of the sixth embodiment, and more specifically, identification information is added to the sensor tag ST of the first to fifth embodiments.

### Configuration of Sixth Embodiment

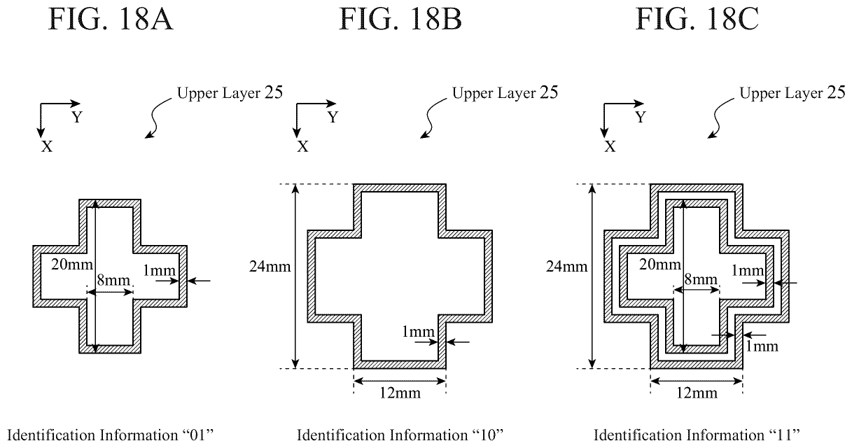

FIGS. 18A to 18C each illustrates a configuration of the sensor tag ST of the sixth embodiment.

The sensor tag ST of the sixth embodiment has a configuration basically similar to the configuration of the sensor tag ST of the second embodiment (illustrated in FIG. 5).

On the other hand, as illustrated in FIGS. 18A to 18C, in the sensor tag ST of the sixth embodiment, unlike the sensor tag ST of the second embodiment, the upper layer 25 has a conductor pattern having a single or double loop structure corresponding to pieces of identification information “01”, “10”, and “11”. As illustrated in FIGS. 18A to 18C, the presence or absence of the inner conductor pattern corresponds to whether the lower bit of the identification information is 1 or 0, and similarly, the presence or absence of the outer conductor pattern corresponds to whether the upper bit of the identification information is 1 or 0.

### Operation of Sixth Embodiment

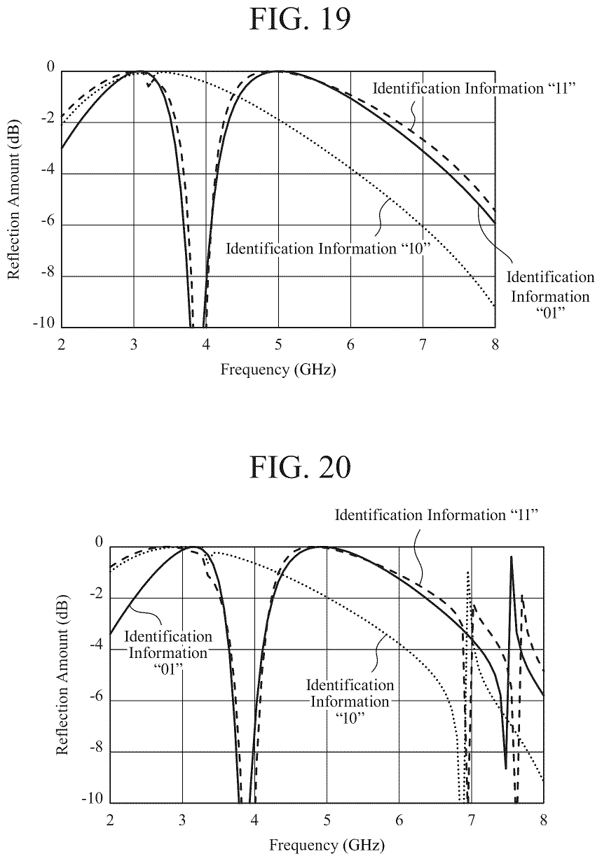

FIG. 19 illustrates frequency characteristics (without displacement) of the reflection amount of the sixth embodiment.

FIG. 20 illustrates frequency characteristics (displacement in the X direction) of the reflection amount of the sixth embodiment.

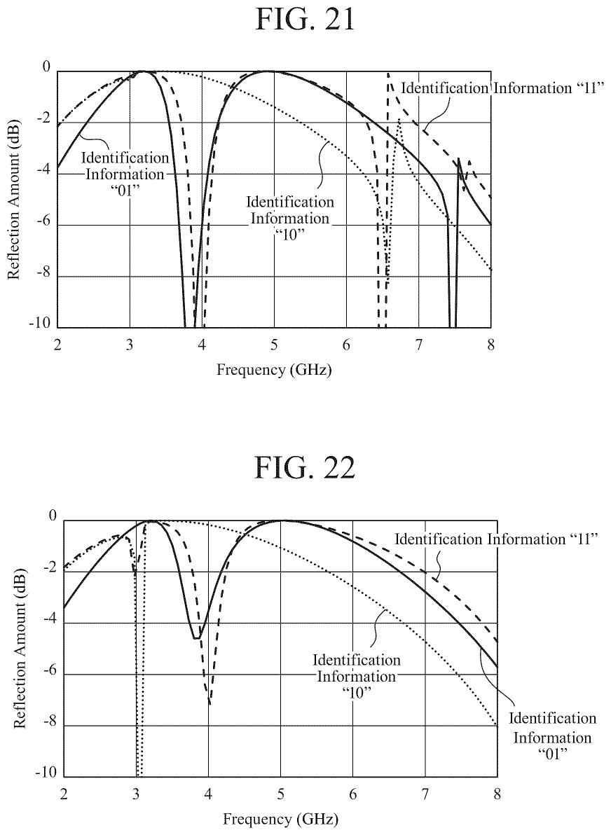

FIG. 21 illustrates frequency characteristics (displacement in the Y direction) of the reflection amount of the sixth embodiment.

FIG. 22 illustrates frequency characteristics (displacement in the Z direction) of the reflection amount of the sixth embodiment.

The sensor tag ST of the sixth embodiment performs an operation basically similar to the operation (illustrated in FIGS. 8 to 11) of the sensor tag ST of the second embodiment.

FIGS. 19 to 22 are calculated by a method similar to that in FIGS. 9 to 11 of the second embodiment. The displacement amounts dx, dy, and dz illustrated in FIGS. 8A to 8C of the second embodiment are 2 mm, 2 mm, and −2 mm, respectively.

Because the structure of the conductor 21a (illustrated in FIG. 5) of the upper layer 25, that is, the presence or absence of the inner conductor pattern and the presence or absence of the outer conductor pattern (illustrated in FIGS. 18A to 18C) are different for each of the pieces of identification information “01”, “10”, and “11”, even if the displacement amount of the object TB is the same, the frequency characteristics of the reflection coefficient or the transmission coefficient of the resonance element 23 (illustrated in FIG. 5) are different for each of the pieces of identification information “01”, “10”, and “11”.

By using the sensor tag ST (illustrated in FIG. 18A) having the identification information “01”, the sensor tag ST (illustrated in FIG. 18B) having the identification information “10”, and the sensor tag ST (illustrated in FIG. 18C) having the identification information “11”, different frequency characteristics are obtained depending on the displacement amount of the object TB. As a result, it is possible to sense the displacement amount of the object TB and to read whether the identification information of the sensor tag ST is “01”, “10”, or “11” on the basis of the situations of reception from the three sensor tags ST.

### Effects of Sixth Embodiment

As described above, in the sensor tag ST of the sixth embodiment, even if the conductivity or dielectric constant of the sensing unit 22 does not change corresponding to the displacement amount of the object TB, the displacement amount of the object TB can be sensed, and the identification information “01”, “10”, and “11” can be read.

### Seventh Embodiment

### Seventh Embodiment

A sensor tag of a seventh embodiment will be described.

The sensor tag ST of the seventh embodiment is applied to, in particular, sensing a variation of the physical quantity BR having temporal periodicity of the object TB and reading the period and amplitude of the variation using the sensor tag ST of the first to sixth embodiments.

### Configuration of Seventh Embodiment

FIG. 23 illustrates an arrangement (part 1) of the sensor tag ST of the seventh embodiment.

FIG. 24 illustrates an arrangement (part 2) of the sensor tag ST of the seventh embodiment.

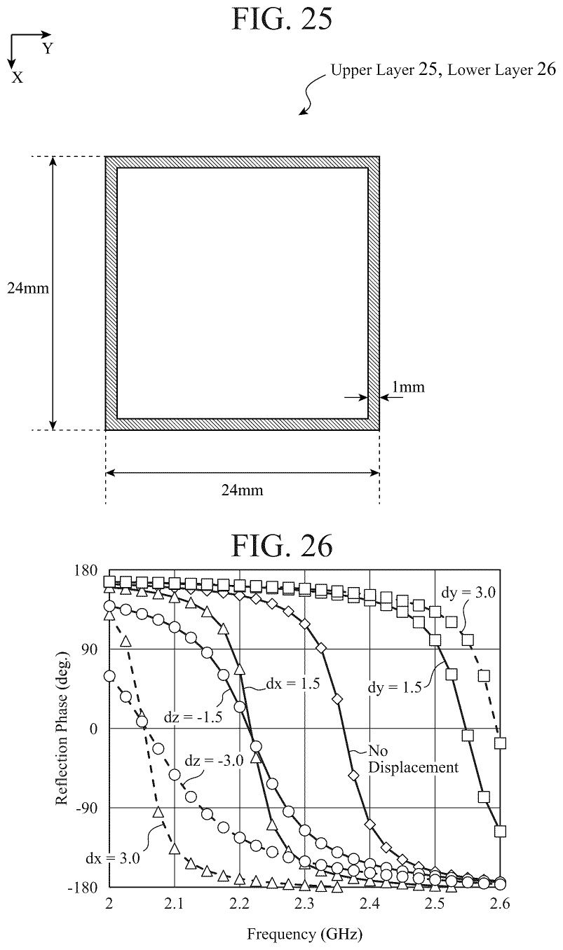

FIG. 25 illustrates a shape and dimensions of the sensor tag ST of the seventh embodiment.

FIG. 26 illustrates an operation of the sensor tag ST of the seventh embodiment.

As illustrated in FIG. 24, the sensor tag ST of the seventh embodiment has a configuration basically similar to the configuration of the sensor tag ST of the second embodiment (illustrated in FIG. 5).

On the other hand, in the sensor tag ST of the seventh embodiment, unlike the sensor tag ST of the second embodiment, as illustrated in FIG. 24, a conductor plate DB is disposed on a back surface of the lower layer 26 of the sensor tag ST with spacers SP interposed therebetween.

The upper layer 25 and the lower layer 26 of the sensor tag ST have shapes and dimensions illustrated in FIG. 25.

As illustrated in FIG. 23, the reading device YS transmits the transmission wave SH to the sensor tag ST, receives the reflected wave HH from the sensor tag ST, and calculates a spectrum of the received reflected wave HH.

### Operation of Seventh Embodiment

In the seventh embodiment, as in the second embodiment, it is assumed that the vibration of the object TB is sensed.

### Basic Principle of Operation

The sensor tag ST of the seventh embodiment operates as follows.

When the physical quantity BR of the object TB changes, the shape of the sensing unit 22 (illustrated in FIG. 5) changes, the relative position between the conductor 21a and the conductor 21b (illustrated in FIG. 5) changes, and the frequency characteristic of the reflection coefficient or the transmission coefficient of the resonance element 23 changes.

The reading device YS observes a spectrum of the reflected wave HH or the like reflected by the sensor tag ST out of the transmission wave SH transmitted from the reading device YS. The reading device YS obtains the frequency of the periodic variation from frequency intervals of the spectrum, and on the other hand, obtains the amplitude of the periodic variation from the pattern of the spectrum.

### Details of Operation

More specifically, the sensor tag ST of the seventh embodiment operates as follows.

The reflection amount of the sensor tag ST is 0 dB due to the presence of the conductor plate DB (illustrated in FIG. 24).

A reflection phase in the sensor tag ST is as illustrated in FIG. 26. FIG. 26 is calculated by a method similar to that in FIGS. 9 to 11 of the second embodiment.

When the sensing unit 22 senses the variation of the physical quantity BR having temporal periodicity, the reflection amount and the reflection phase of the resonance element 23, in other words, the reflection coefficient has temporal periodicity.

Therefore, a reflection coefficient R is expressed by the following Fourier series.

$$R ( t ) = {\sum }_{n = - ∞}^{∞} {C}_{n} {e}^{j 2 π n {f}_{v} t} \qquad ( 1 )$$

Cn is an nth-order coefficient, fv is a variation frequency of the physical quantity BR of the object TB, and t is time. The coefficient Cn is obtained as follows.

$${C}_{n} = \frac{1}{{T}_{v}} {\int }_{0}^{{T}_{v}} R ( t ) {e}^{- j 2 π {nf}_{v} t} d t \qquad ( 2 )$$

Tv is a variation period of the physical quantity BR of the object TB, and is a reciprocal of fv. From the above equation, an electric field Er of the reflected wave HH is expressed as follows.

$${E}_{r} ( t ) = {\sum }_{n = - ∞}^{∞} {C}_{n} {e}^{j 2 π n {f}_{v} t} {E}_{i} ( t ) = A {\sum }_{i = - ∞}^{∞} {C}_{n} {e}^{j 2 π ( {f}_{i} + {nf}_{v} ) t} \qquad ( 3 )$$

Ei is an electric field of the transmission wave SH radiated by the reading device YS, and A and fi are amplitude and frequency of Ei, respectively. As described above, when the reading device YS emits the transmission wave SH having a single frequency fi, the reflected wave HH has a harmonic component fi+nfv in addition to fi.

The reading device YS transmits the transmission wave SH of a single frequency. When the physical quantity BR of the object TB varies temporally periodically, the harmonic component calculated by the above equation appears in the spectrum of the reflected wave HH.

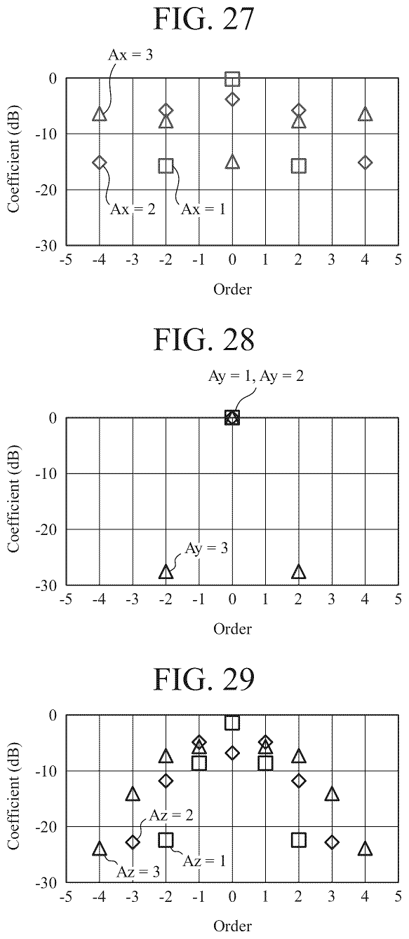

FIG. 27 illustrates calculation results (vibration in the X direction) of an nth-order coefficient Cn of the seventh embodiment.

FIG. 28 illustrates calculation results (vibration in the Y direction) of an nth-order coefficient Cn of the seventh embodiment.

FIG. 29 illustrates calculation results (vibration in the Z direction) of an nth-order coefficient Cn of the seventh embodiment.

Ax, Ay, and Az are amplitudes (in mm) of the vibration of the object TB.

FIGS. 27 to 29 assume that X polarized waves are incident.

Cn represents the amplitude of a frequency component of an nth harmonic, and thus the spectrum of the reflected wave HH also has a pattern similar to that illustrated in FIGS. 27 to 29.

The spectrum described above is a discrete spectrum having a component at the frequency of (fi+nfv). The frequency intervals of the spectrum are determined by fv, that is, the frequency of the periodic variation.

The pattern of the spectrum is determined by the amplitude of the periodic variation. Therefore, the frequency and the amplitude of the periodic variation can be estimated by referring to the correspondence relationship between the spectrum of the reflected wave HH calculated in advance or acquired by experiment and the spectrum of the observed reflected wave HH.

### Effects of Seventh Embodiment

As described above, in the seventh embodiment, for example, the variation frequency and the variation amplitude of the physical quantity BR of the object TB can be read without obtaining the spectrum of the reflected wave by scanning the frequency of the electromagnetic wave emitted by the reading device YS, that is, by setting the frequency of the transmission wave SH transmitted by the reading device YS to a single frequency, observing the harmonic component that appears when the physical quantity BR of the object TB varies temporally, and analyzing the pattern of the observed harmonic component.

### Eighth Embodiment

### Eighth Embodiment

A sensor tag system of an eighth embodiment will be described.

A sensor system SS of the eighth embodiment uses the sensor tag ST of the first to seventh embodiments, in order to detect a failure and an abnormality of electrical equipment, a structure, and the like which are the monitoring target KTB, the states of the electrical equipment, the structure, and the like are monitored.

### Configuration of Eighth Embodiment

FIG. 30 illustrates a configuration of the sensor system SS of the eighth embodiment.

As illustrated in FIG. 30, the sensor system SS of the eighth embodiment includes sensor tags ST1 to ST3 (corresponding to the sensor tag ST of the first to seventh embodiments). As illustrated in FIG. 30, the sensor tags ST1 to ST3 are arranged on surfaces of electric devices, structures, and the like which are the monitoring target KTB.

### Operation of Eighth Embodiment

The reading device YS acquires a change (for example, vibration of a bridge, vibration of a structure, and electromagnetic noise in a structure and in the vicinity of an electronic device) in the physical quantity BR of the monitoring target KTB through the sensor tags ST1 to ST3 using the sensing method described in the first to seventh embodiments.

The reading device YS compares the acquired physical quantity BR of the monitoring target KTB with, for example, a predetermined threshold to determine whether or not an abnormality has occurred in the monitoring target KTB.

### Effects of Eighth Embodiment

As described above, in the sensor system SS of the eighth embodiment, it is possible to monitor the state of the monitoring target KTB such as an electric device and a structure by using the sensor tag ST of the first to seventh embodiments, that is, by using the sensor tag ST that achieves the effects of the first to seventh embodiments.

### Ninth Embodiment

### Ninth Embodiment

A sensor system of a ninth embodiment will be described.

The sensor system SS of the ninth embodiment uses the sensor tag ST of the first to seventh embodiments to identify an individual such as an electronic device and a robot. For example, the identification information (illustrated in FIGS. 18A to 18C) described in the sixth embodiment is used for the identification.

In addition to the above identification, the sensor system SS of the ninth embodiment identifies an individual by using what are called artifact metrics, more specifically, features of the individual in which the sensor tag ST is disposed.

### Configuration of Ninth Embodiment

FIG. 31 illustrates a configuration of the sensor system SS of the ninth embodiment.

As illustrated in FIG. 31, the sensor system SS of the ninth embodiment includes a sensor tag ST (corresponding to the sensor tag ST of the first to seventh embodiments).

### Operation of Ninth Embodiment

The reading device YS acquires a change in the physical quantity BR (for example, vibration and electromagnetic noise of an unmanned aerial vehicle, and electromagnetic noise of an electronic device) of the identification target STB (for example, an unmanned aerial vehicle) through the sensor tag ST using the sensing method described in the first to seventh embodiments.

The reading device YS compares the acquired physical quantity BR of the identification target STB with, for example, a threshold determined by artifact metrics, for example, information acquired in advance indicating a relationship between the type of the individual, the identification information, and the physical quantity BR, thereby determining whether or not the identification target STB is true or false, that is, whether or not the identification target STB is genuine.

### Effects of Ninth Embodiment

As described above, in the sensor system SS of the ninth embodiment, it is possible to identify an individual such as an electronic device and a robot using the sensor tag ST of the first to seventh embodiments, that is, using the sensor tag ST that achieves the effects of the first to seventh embodiments.

The above-described embodiments may be combined without departing from the gist of the present disclosure, and components in each embodiment may be appropriately eliminated, changed, or other components may be added.

### INDUSTRIAL APPLICABILITY

A sensor tag according to the present disclosure can be used to sense a physical quantity of an object even if a sensing unit does not change in conductivity or a dielectric constant even though the physical quantity of the object changes.

### REFERENCE SIGNS LIST

11a: conductor, 11b: conductor, 12: sensing unit, 13: resonance element, 21a: conductor, 21b: conductor, 22: sensing unit, 23: resonance element, 24a: substrate, 24b: substrate, 25: upper layer, 26: lower layer, 31a: conductor, 31b: conductor, 32: sensing unit, 33: resonance element, 41a: conductor, 41b: conductor, 42: sensing unit, 43: resonance element, 44: substrate, 51a: conductor, 51b: conductor, 52: main sensing unit, 52a: sub-sensing unit, 52b: sub-sensing unit, BR: physical quantity, BR1: physical quantity, BR2: physical quantity, CA: capacitor, Cn: coefficient, DK: electric circuit, dx: displacement amount, dy: displacement amount, dz: displacement amount, Er: electric field, fi: single frequency, HH: reflected wave, IN: inductor, KTB: monitoring target, R: reflection coefficient, SH: transmission wave, SP: spacer, SS: sensor system, ST: sensor tag, ST1: sensor tag, ST3: sensor tag, STB: identification target, TB: object, TB1: object, TB2: object, TE: resistor, YS: reading device

1. A sensor tag comprising:
a plurality of conductors arranged close to each other and to constitute a resonance element; and
a sensing member interposed between the plurality of conductors and having a physical property that changes due to a change in a physical quantity of an object to be sensed by the sensing member.

2. The sensor tag according to claim 1, wherein
relative positions of the plurality of conductors change in accordance with a change in a shape of the sensing member.

3. The sensor tag according to claim 2, wherein
the sensing member is a spring.

4. The sensor tag according to claim 1, wherein
the sensing member includes an electric circuit whose circuit constant changes in accordance with a change in a physical quantity of the object.

5. The sensor tag according to claim 4, wherein
the electric circuit includes an active element.

6. A sensor tag comprising:
a plurality of conductors arranged close to each other and to constitute a resonance element; and
a main sensing member and a sub-sensing member which are interposed between the plurality of conductors, in which a physical property of the main sensing member changes due to a change in a physical property of the sub-sensing member due to a change in a physical quantity of an object to be sensed by the main sensing member and the sub-sensing member.

7. The sensor tag according to claim 6, wherein
the sub-sensing member is able to sense vibration that is a physical quantity of the object, and
the main sensing member includes an active element whose physical properties change by receiving application of a voltage generated due to sensing of the vibration by the sub-sensing member.

8. The sensor tag according to claim 1, further comprising:
at least one conductor pattern to indicate identification information.

9. The sensor tag according to claim 8, wherein
the at least one conductor pattern has a loop shape.

10. The sensor tag according to claim 1, wherein
a plurality of elements, each of the plurality of elements having the plurality of conductors and the sensing member, are two-dimensionally arranged.

11. A method for reading a sensor tag, the method comprising:
estimating a period and amplitude of variation of a physical quantity of the object due to a change in a reflection characteristic or a transmission characteristic of the sensor tag according to claim 1 in response to receiving irradiation of a transmission wave of a single frequency.

12. The method for reading a sensor tag according to claim 11, wherein
a period and amplitude of vibration of the object are estimated.

13. The method for reading a sensor tag according to claim 11, wherein
a period and amplitude of vibration of electromagnetic noise are estimated.

14. A sensor system comprising:
the sensor tag according to claim 1.

15. The sensor system according to claim 14, wherein
a state of the object is monitored.

16. The sensor system according to claim 14, wherein
individual identification of the object is performed.
